(19) United States
(12) Patent Application Publication
(10) Pub. No.: US 2017/0141950 A1
(43) Pub. Date: May 18, 2017

(54) RESCHEDULING A SERVICE ON A NODE

(71) Applicant: HEWLETT PACKARD ENTERPRISE DEVELOPMENT LP, Houston, TX (US)

(72) Inventors: Shaun Wackerly, Roseville, CA (US); Julie BRITT, Roseville, CA (US); Marjorie KRUEGER, Roseville, CA (US)

(21) Appl. No.: 15/300,270

(22) PCT Filed: Mar. 28, 2014
(86) PCT No.: PCT/US2014/032155

§ 371 Date: Sep. 28, 2016

(51) Int. Cl. H04L 12/24; H04L 12/26

(52) U.S. Cl. CPC H04L 41/0659; H04L 43/0817; H04L 41/5025

(57) ABSTRACT

A controller detects that an agent of a first node managed by the controller is unavailable, the agent providing a service accessible by a tenant of a cloud infrastructure that includes the controller and a plurality of nodes managed by the controller. In response to the detecting, the controller reschedules the service on a second node managed by the controller to continue to provide availability of the service to the tenant. As part of the rescheduling, cooperate, by the controller, with the first node to avoid duplication of the service on multiple nodes including the first and second nodes.

### BACKGROUND

A network infrastructure composed of various network entities can be used by devices to communicate with each other. Examples of network entities include switches, routers, configuration servers (e.g. Dynamic Host Configuration Protocol or DHCP servers), and so forth.

Traditionally, the network infrastructure of a particular network is owned by a network operator. For example, an enterprise, such as a business concern, educational organization or government agency, can operate a network for use by users (e.g. employees, customers, etc.) of the enterprise. The network infrastructure of such network is owned by the enterprise.

In an alternative arrangement, instead of using a network operator's own network infrastructure to implement a network, the network operator can instead pay to use networking entities provided by a third party service provider. The service provider provides an infrastructure that includes various network entities accessible by customers (also referred to as “tenants”) of the service provider. By using the infrastructure of the service provider, an enterprise would not have to invest in various components of a network infrastructure, and would not have to be concerned with maintenance of the network infrastructure. In this way, an enterprise's experience in setting up a network configuration is simplified. In addition, flexibility is enhanced since the network configuration can be more easily modified for new and evolving data flow patterns. Moreover, the network configuration is scalable to meet rising data bandwidth demands.

### BRIEF DESCRIPTION OF THE DRAWINGS

Some implementations are described with respect to the following figures.

FIG. 1 is a block diagram of an example arrangement that includes a network cloud infrastructure and tenant systems, according to some implementations.

FIG. 2 is a flow diagram of a rescheduling process according to some implementations.

FIG. 3 is a flow diagram of a decommissioning process according to some implementations.

FIG. 4 is a flow diagram of a rejoin control process according to some implementations.

FIG. 5 is a block diagram of a controller according to some implementations.

### DETAILED DESCRIPTION

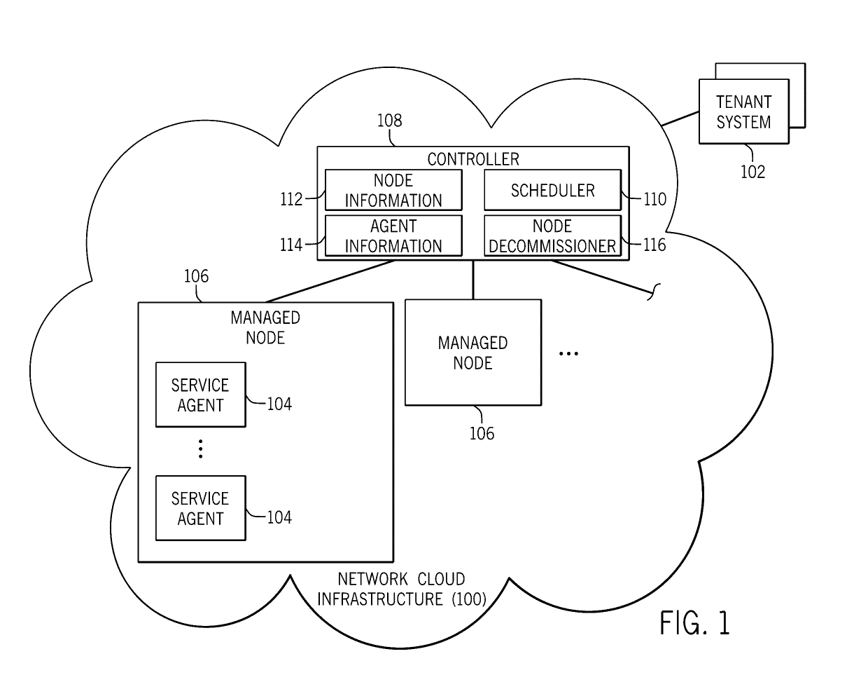

FIG. 1 is a block diagram of an example arrangement that includes a network cloud infrastructure 100, which may be operated and/or owned by a network service provider. The network cloud infrastructure 100 has customers (also referred to as “tenants”) that operate respective tenant systems 102. Each tenant system 102 can include a network deployment that uses network entities of the network cloud infrastructure 100. The provision of network entities of a network cloud infrastructure by a network service provider to a tenant is part of a cloud-service model that is sometimes referred to as network as a service (NaaS) or infrastructure as a service (IaaS).

The network cloud infrastructure 100 includes both physical elements and virtual elements. The physical elements include managed nodes 106, which can include computers, physical switches, and so forth. The virtual elements in the network cloud infrastructure 100 are included in the managed nodes 106. More specifically, the managed nodes 106 include service agents 104 that provide virtual network services that are useable by the tenant systems 102 on demand.

A service agent 104 can be implemented as machine-readable instructions executable within a respective managed node 106. A service agent 104 hosts or provides a virtual network service that can be used in a specific network configuration of a tenant system 102. Each managed node 106 can include one or multiple service agents 104, and each service agent 104 can provide one or multiple virtual network services.

Virtual network services provided by service agents 104 can include any or some combination of the following: a switching service provided by a switch for switching data between devices at layer 2 of the Open Systems Interconnection (OSI) model; a routing service for routing data at layer 3 of the OSI model;a configuration service provided by a configuration server, such as a Dynamic Host Configuration Protocol (DHCP) server used for setting network configuration parameters such as Internet Protocol (IP) addresses for devices that communicate over a network; a security service provided by a security enforcement entity for enforcing a security policy; a domain name service provided by a domain name system (DNS) server that associates various information (including an IP address) with a domain name; and so forth.

Although examples of various network services are listed above, it is noted that service agents 104 can provide other types of virtual network services that are useable in a network deployment of a tenant system 102.

A virtual network service, or an agent that provides a virtual network service, constitutes a virtual network element in the network cloud infrastructure 100. The virtual network entities are “virtual” in the sense that the network entities are not physical entities within a network deployment of a respective tenant system 102, but rather entities (provided by a third party such as the network service provider of the network cloud infrastructure 100) that can be logically implemented in the network deployment.

More generally, a cloud infrastructure can include service agents 104 that provide virtual services useable in a tenant system 102. Such virtual services can include services of processing resources, services of storage resources, services of software (in the form of machine-readable instructions), and so forth.

In the ensuing discussion, reference is made to provision of virtual network services. However, techniques or mechanisms according to some implementations can be applied to other types of virtual services provided by nodes of a cloud infrastructure.

When a fault occurs in the network cloud infrastructure 100 that causes a managed node 106 or a service agent 104 in a managed node 106 to go down (enter into a low power mode or off state, enter into a failed state, or otherwise enter into a state where the managed node 106 or service agent 104 becomes non-operational), a virtual network service may become temporarily unavailable. Examples of faults in the network cloud infrastructure 100 can cause a managed node 106 or an agent 104 to become unavailable can include any or some combination of the following: failure of a physical element such as a component in a managed node 106, an error during execution of machine-readable instructions, loss of communication over a physical network link, and so forth.

As another example, an administrator of the network cloud infrastructure 100 may issue an instruction to decommission a managed node 106, which will also cause a corresponding virtual network service to become unavailable. Decommissioning a managed node 106 refers to taking the managed node 106 out of service, which can be performed to repair, upgrade, or replace the decommissioned managed node 106, as examples. As discussed further below, decommissioning of a managed node 106 can be performed by a node decommissioner 116 executing in the controller 108 (or another system). The node decommissioner 116 can be implemented as machine-readable instructions.

In either scenario (a first scenario where a fault causes a managed node or service agent to go down, or a second scenario in which a managed node is decommissioned), a tenant system 102 that uses a virtual network service associated with the managed node 106 or service agent 104 that has gone down may notice that the virtual network service has become unavailable (the virtual network service can no longer be used by the tenant system 102). The detection of the unavailability of the virtual network service by the tenant system 102 may cause disruption of operation of the tenant system 102,

If disruption is detected at the tenant system 102, an administrator of the tenant system 102 (or alternatively, an administrator of the network cloud infrastructure 100) may have to perform manual re-configuration of a network deployment at the tenant system 102 to address the disruption due to unavailability of the virtual network service. Such manual re-configuration may take a relatively long period of time, and also may be labor intensive.

In accordance with some implementations, a controller 108 in the network cloud infrastructure 100 is able to perform rescheduling of a virtual network service on a different managed node 106 in response to the controller 108 detecting that a service agent providing the virtual network service has become unavailable, in any of the scenarios discussed above. Rescheduling the virtual network service includes causing the virtual network service to be provided by a second service agent instead of by a first service agent (which has become unavailable). The first service agent is executed in a first managed node 106, while the second service agent is executed in a second managed node 106.

By performing the automatic rescheduling of the virtual network service on a different managed node 106, service disruption at a tenant system 102 can be avoided. From the perspective of the tenant system that uses the virtual network service provided by the service agent that has become unavailable, the virtual network service appears to be continually available during the rescheduling. As a result, seamless availability of the virtual network service is provided to the tenant system 102 in the presence of a fault or a decommissioning action that causes a service agent 104 to become unavailable.

The controller 108 can be a controller that manages the managed nodes 106 in the network cloud infrastructure 100. The controller 108 is able to direct which virtual network services are provided by service agents on which managed nodes 106. Although just one controller 108 is shown in FIG. 1, it is noted that in other examples, the network cloud infrastructure 100 can include multiple controllers 108 for managing the managed nodes 106.

In some examples, the arrangement shown in FIG. 1 in which the controller 108 manages managed nodes 106 can be part of a software-defined networking (SON) arrangement, in which machine-readable instructions executed by the controller 108 perform management of the managed nodes 106. In the SON arrangement, the controller 108 is referred to as an SDN controller that is part of a control plane, while the managed nodes 106 are part of a data plane through which user or tenant traffic is communicated. User or tenant traffic does not have to be communicated through the control plane. The controller 108 is responsible for determining where (which of the managed nodes 106) a virtual network service is to be hosted, while a managed node is responsible for deploying a specific network service.

In some examples, communications between the controller 108 and the managed nodes 106 can be according to a Representational State Transfer (REST) protocol. In other examples, communications between the controller 108 and the managed nodes 106 can be according to other protocols.

The rescheduling of a virtual network service from a first managed node 106 to a second managed node 106 due to unavailability of a service agent can be performed by a scheduler 110 that executes in the controller 108. The scheduler 110 can be implemented as machine-readable instructions, in some examples.

The controller 108 can maintain node information 112 describing physical attributes of each managed node 106. The physical attributes of a managed node 106 can include any or some combination of the following: number of processors, processor speed, type of operating system, storage capacity, and so forth. The controller 108 also maintains agent information 114, which relates to a service agent(s) of each managed node 106. The information pertaining to the service agent(s) include information describing the capability of each service agent to host a respective virtual network service, information associating a service agent with a corresponding managed node 106, and other information relating to characteristics of each service agent. Service agents 104 can send their information to the controller 108, on a repeated basis, for inclusion in the agent information 114.

The node information 112 and agent information 114 can be stored in a storage medium within the controller 108, or in a storage medium outside the controller 108.

When a tenant system 106 wishes to employ a given virtual network service, the controller 108 can schedule the requested virtual network service on a selected service agent 104 residing on a corresponding managed node 106. More specifically, the tenant system 102 can submit a request for certain virtual network services. In response to the request, the controller 108 can determine which service agents 104 on which managed nodes 106 are to host the requested virtual network services.

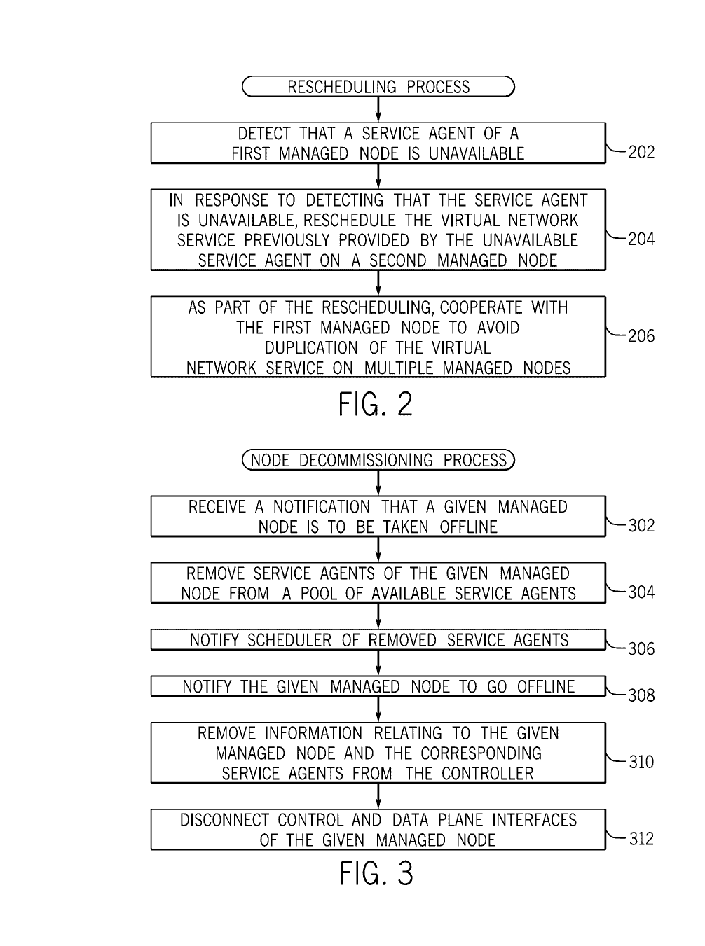

FIG. 2 is a flow diagram of a process for rescheduling a virtual network service, in accordance with some implementations. The process can be performed by components (including the scheduler 110) in the controller 108. The controller 108 detects (at 202) that a first service agent 104 of a first managed node 106 is unavailable. As noted above, the unavailability of the first service agent 104 can be due to a fault in the network cloud infrastructure 100, or due to an explicit action to decommission the first managed node 106.

Detecting unavailability of a service agent can be based on checking for a heartbeat message from the service agent. If the controller 108 determines that the service agent 104 has not reported availability (by sending a heartbeat message), then the controller 108 makes a determination that the service agent is unavailable, and the status of the service agent 104 is marked accordingly. In some examples, the controller 108 can provide an alert service configured to send notification of an unavailable service agent (along with other specified events) to a designated recipient, such as an administrator of the network cloud infrastructure 100.

In response to detecting that the first service agent 104 is unavailable, the scheduler 110 in the controller 108 reschedules (at 204) the virtual network service previously provided by the unavailable service agent 104 on a second managed node 106, to continue to provide availability of the virtual network service to a tenant system 102. As part of the rescheduling, the controller 108 cooperates (at 206) with the first managed node 106 to avoid duplication of the virtual network service on multiple nodes that include the first and second managed nodes.

In some implementations, the network cloud infrastructure 100 can be configured with a first physical network for communication of management traffic between the controller 108 and the managed nodes 106, and a second, different physical network for tenant data connections (for communicating data of network deployments of the tenant systems 102). A condition that results in the controller 108 losing contact with a service agent may not represent loss of the respective virtual network service to a tenant system 102 because of the separate management and tenant data networks. For example, if a managed node 106 loses its management network connectivity to the controller 108, it may appear to the controller 108 that the service agents 104 on that managed node 106 have become unavailable, even though the service agents are still running on the managed node 106, and thus providing tenant services to a tenant over the tenant data network. In this scenario, when the controller 108 reschedules the virtual network service of a first service agent to a second service agent, duplicate virtual network services (one provided by the first service agent and another provided by the second virtual service agent) may be provided for a network deployment of the tenant system 102.

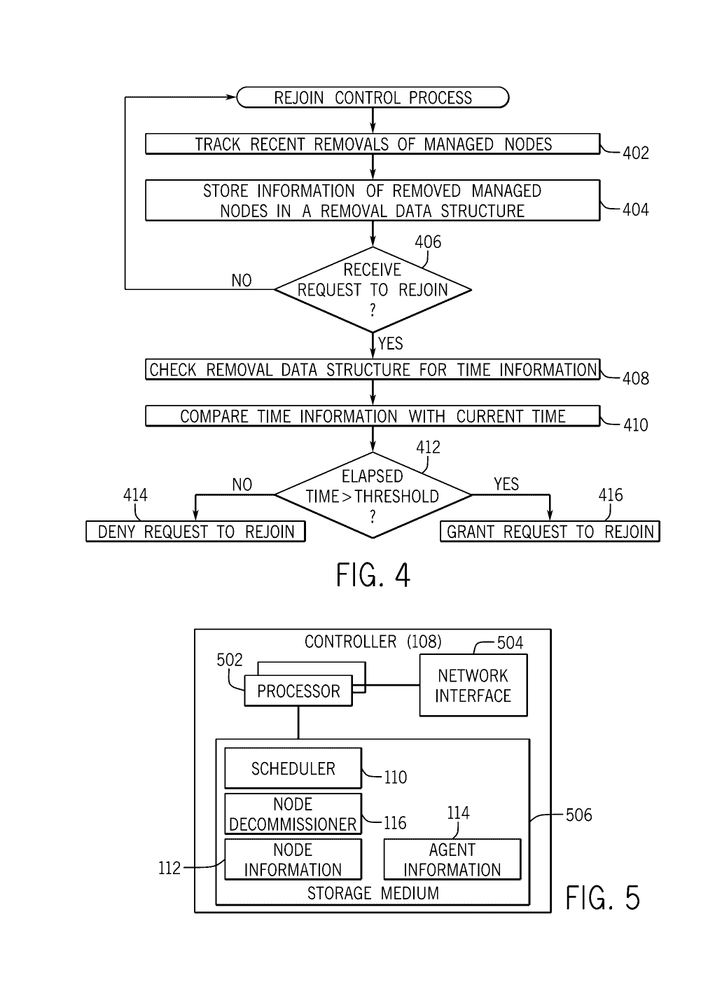

The cooperation (206) between the controller 108 and the first managed node 106 to avoid duplication of a virtual network service can involve the following tasks, in some implementations. Both the first managed node 106 and the controller 108 are configured to detect loss of management connectivity. If the first managed node 106 detects the loss of management connectivity to the controller 108, then the first managed node 106 can decommission all virtual network services on the first managed node 106, in anticipation of the controller 108 rescheduling such virtual network services on another managed node (or other managed nodes) 106. The process of decommissioning the virtual network services and rescheduling the virtual network services can be performed relatively quickly so that tenant systems 102 do not notice the temporary unavailability of the virtual network services. In addition, to prevent a “flapping rescheduling” condition (where the controller reschedules a virtual network service from a first managed node 106 to a second managed node 106, followed quickly by rescheduling the same virtual network service back from the second managed node 106 to the first managed node 106), the controller 108 can perform actions to prevent rejoinder of the first managed node 106 with which the controller 108 has recently lost communication, similar to actions performed according to FIG. 4 (discussed further below).

In addition to being able to reschedule virtual network services in response to detecting unavailability of service agents, the scheduler 110 of the controller 108 can also perform load balancing to balance workload across the managed nodes 106. Re-balancing workload across the managed nodes 106 can be accomplished by rescheduling, using the scheduler 110, virtual network services across different service agents 104 in the managed nodes 106. The network cloud infrastructure 100 may change over time, such as due to addition of new managed nodes 106 and/or new service agents 104. When the new managed nodes 106 and/or new service agents 104 register with the controller 108, the scheduler 110 can perform rescheduling of virtual network services to perform re-balancing of workload.

In some cases, new managed nodes and/or new service agents may possess greater performance characteristics or enhanced service features. By rescheduling virtual network services to such new managed nodes and/or new service agents, the controller 108 can better balance workload across the managed nodes 106, as well as to take advantage of enhanced performance characteristics or service features. Rebalancing virtual network services can also provide greater reliability as more managed nodes 106 are deployed into the network cloud infrastructure 100. The ability of the network cloud infrastructure 100 to tolerate node failure without service interruption is a factor of the available unused service hosting capacity across the managed nodes 106. In network cloud infrastructure with N managed nodes capable of hosting virtual network services, if N-1 nodes fail, all services might end up hosted on the remaining node. As the failed nodes become available again, rebalancing allows the virtual network services to be redistributed across the available nodes, to achieve better usage of available resources for providing virtual network services.

FIG. 3 is a flow diagram of a node decommissioning process according to some implementations. The decommissioning process can be performed by the node decommissioner 116, in some examples, or by a different module, whether executing on the controller 108 or on another system. The node decommissioner 116 receives (at 302) a notification (such as from an administrator of the network cloud infrastructure 100 or another requester) that a given managed node 106 is to be taken offline.

In response to the notification, the node decommissioner 116 removes (at 304) the service agents of the given managed node 106 from a pool of available service agents. The pool of available service agents can be stored as part of the agent information 114 (FIG. 1). After removing the service agents of the given managed node 106 from the pool of available service agents, the controller 108 allows service agents 104 on the given managed node 106 to finish processing any remaining service requests.

The node decommissioner 116 can further notify (at 306) the scheduler 110 of the service agents that are removed from the pool of available service agents. This notification can cause the scheduler 110 to begin the computations relating to rescheduling of the virtual network services provided by the service agents that have been removed. Such computations can allow the rescheduling of the hosted virtual network services of the given managed node 106 to complete more quickly at a later time.

The node decommissioner 116 then notifies (at 308) the given managed node 106 to go offline so that the given managed node 106 can prepare to shut down or otherwise become inactive. This notification indicates to the given managed node 106 that the controller 108 is no longer controlling the given managed node 106.

Next, the node decommissioner 116 removes (at 310) information relating to the given managed node 106 and the corresponding service agents from the controller 108, such as by removing such information from the node information 112 and the agent information 114 (FIG. 1). Removing the information relating to the given managed node 106 and the corresponding service agents from the controller 108 triggers virtual network services provided by the service agents to be rescheduled by the scheduler 110 to another service agent (or other service agents).

The node decommissioner 116 further disconnects (at 312) the given managed node's control and data plane network interfaces so that the given managed node's service hosting capacity effectively ceases to exist from the network cloud infrastructure 100. The control plane network interface of the given managed node 106 is used to communicate with the controller 108, while the data plane interface of the given managed node 106 is used to communicate data with other network entities.

FIG. 4 is a flow diagram of a rejoin control process that can be performed by the node decommissioner 116, or by another module. The node decommissioner 116 tracks (at 402) recent removals of managed nodes (such as performed at 310 in FIG. 3). When information of a managed node 106 is removed from the controller 108, the node decommissioner 116 stores (at 404) information relating to the removed managed node 106 in a removal data structure (e.g. cache, log, etc.) that contains information of recently removed managed nodes. The data structure can store identifiers of the removed managed nodes, as well as time information indicating the latest time when each managed node 106 was removed from the view of the controller 108.

When a managed node 106 is notified that the controller 108 has removed the managed node from the controller's view, the managed node 106 may attempt to rejoin the controller 108. A managed node rejoining the controller 108 refers to the managed node 106 performing a registration procedure with the controller 108 to make the controller 108 aware of the presence and availability of the managed node 106. If the controller 108 allows the recently removed managed node 106 to fully rejoin the controller 108, then new virtual network services may be scheduled onto the rejoined managed node 106 even though the rejoined managed node 106 is being brought offline.

In accordance with some implementations, in response to receiving (at 406) a request from a given managed node 106 to rejoin the controller 108, the node decommissioner 116 checks (at 408) the removal data structure to determine if the removal data structure contains time information regarding when the given managed node 106 was removed. If the time information is in the removal data structure, then the node decommissioner 116 compares (at 410) the time information from the removal data structure with a current time to determine (at 412) if the elapsed time (time since removal of the given managed node) is greater than a specified threshold. If not, then the request to rejoin is denied (at 414) by the node decommissioner 116. If the elapsed time is greater than the specified threshold, then the node decommissioner 116 grants (at 416) the request to rejoin.

In some examples, the denial of the request to rejoin is a denial of the request to fully rejoin the recently removed managed node 106. The node decommissioner 116 can still allow rejoining of the recently removed managed node 106 in a partial capacity, where the recently removed managed node 106 is excluded from the pool of managed nodes on which virtual network services can be scheduled. However, the partially rejoined managed node 106 can remain operational to allow for interaction with an administrator through the controller 108, for example.

By using techniques or mechanisms according to some implementations, tenant cloud service availability is not interrupted by faults or node decommissioning in the network cloud infrastructure 100. As a result, an administrator can fix infrastructure issues in the network cloud infrastructure 100 without interrupting service to tenants. By rescheduling services automatically, the execution of virtual network services can remain stable even if the underlying infrastructure is changing.

FIG. 5 is a block diagram of an arrangement of the controller 108 according to some implementations. The controller 108 can include one or multiple processors 502, which can be coupled to one or multiple network interfaces 504 (to allow the controller 108 to communicate over a network), and to a non-transitory machine-readable or computer-readable storage medium 506 (or multiple storage media). The storage medium or storage media 506 can store the scheduler 110 and the node decommissioner 116 in the form of machine-readable instructions, as well as the node information 112 and agent information 114. The scheduler 110 or node decommissioner 116 can be loaded from the storage medium or storage media 506 for execution on the processor(s) 502. A processor can include a microprocessor, microcontroller, processor module or subsystem, programmable integrated circuit, programmable gate array, or another control or computing device.

The storage medium (or storage media) 506 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
detecting, by a controller including a processor, that an agent of a first node managed by the controller is unavailable, the agent providing a service accessible by a tenant of a cloud infrastructure that includes the controller and a plurality of nodes managed by the controller;
in response to the detecting, rescheduling, by the controller, the service on a second node managed by the controller to continue to provide availability of the service to the tenant; and
as part of the rescheduling, cooperating, by the controller, with the first node to avoid duplication of the service on multiple nodes including the first and second nodes.

2. The method of claim 1, wherein avoiding the duplication of the service comprises decommissioning the service on the first node.

3. The method of claim 1, wherein detecting that the agent of the first node is unavailable comprises determining that a message has not been received from the first node for greater than a specified time period.

4. The method of claim 1, wherein the agent of the first node is unavailable due to decommissioning of the first node.

5. The method of claim 4, further comprising:
in response to a notification of decommissioning of the first node,
removing agents on the first node from a pool of available agents; and
notifying the first node to go offline.

6. The method of claim 5, further comprising:
in response to the notification of decommissioning of the first node,
removing information pertaining to the first node from information maintained by the controller; and
triggering the rescheduling in response to removing the information pertaining to the first node.

7. The method of claim 1, wherein the rescheduling provides seamless availability of the service to the tenant such that the tenant is not aware of a temporary unavailability of the service due to the agent being unavailable.

8. The method of claim 1, wherein the service provided by the agent comprises a virtual network service for use in a network of a tenant system.

9. The method of claim 1, further comprising:
storing, by the controller, time information relating to when a given node was decommissioned; and
using, by the controller, the time information to prevent the given node from rejoining the controller in a capacity that allows services to be scheduled on the given node.

10. A system comprising;
a plurality of managed nodes; and
a controller comprising at least one processor to:
manage the plurality of managed nodes that include agents providing network services in a cloud infrastructure, the network services useable in networks of tenants of the cloud infrastructure;
detect that an agent of a first of the plurality of managed nodes is unavailable;
in response to the detecting, rescheduling the service on a second of the plurality of managed nodes managed by the controller to continue to provide availability of the service to a tenant; and
wherein the first managed node is to decommission the service on the first managed node to avoid duplication of the service on multiple managed nodes.

11. The system of claim 10, wherein the controller is to further rebalance services across the plurality of managed nodes.

12. The system of claim 10, wherein the controller is to reschedule services onto particular managed nodes that have rejoined the controller after the particular managed nodes were previously removed.

13. The system of claim 10, wherein the controller is to further;
receive a notification that the first managed node is to go offline; and
in response to the notification, remove information of the first managed node and information of agents on the first managed node from the controller.

14. The system of claim 13, wherein the controller is to further:
store time information regarding when the first managed node was removed;
in response to receiving, from the first managed node, a request to rejoin the controller, use the time information to determine an elapsed time since the first managed node was removed; and
decide to grant or deny the request to rejoin based on the determined elapsed time.

15. An article comprising at least one non-transitory machine-readable storage medium storing instructions that upon execution cause a controller to:
detect that an agent of a first node of a plurality of nodes managed by the controller is unavailable, the agent providing a service accessible by a tenant of a cloud infrastructure that includes the controller and the plurality of nodes;
in response to the detecting, reschedule the service on a second of the plurality of nodes to provide seamless availability of the service to the tenant; and
as part of the rescheduling, cooperate with the first node to avoid duplication of the service on multiple nodes including the first and second nodes.
